(19) United States
(12) Patent Application Publication
(10) Pub. No.: US 2011/0287763 A1
(43) Pub. Date: Nov. 24, 2011

(54) TELEPHONE RECEIVING SYSTEM AND METHOD, AND TELEPHONE DEVICE

(75) Inventors: Shingo Fujimoto, Kawasaki (JP); Kazuki Matsui, Kawasaki (JP)

(73) Assignee: FUJITSU LIMITED, Kawasaki-shi (JP)

(21) Appl. No.: 12/950,482

(22) Filed: Nov. 19, 2010

(30) Foreign Application Priority Data
Nov. 20, 2009 (JP) 2009-265370

(51) Int. Cl. H04W 24/00

(52) U.S. Cl. 455/425

(57) ABSTRACT

A telephone device includes a telephone device includes a dialing operation receiving unit that receives a dialing operation, a creating unit that creates condition data that indicates a condition of a function of the telephone device when a telephone number that received by the dialing operation receiving unit is matched with a specified number; and a sending unit that sends the created condition data to a desired destination.

### CROSS-REFERENCE TO RELATED APPLICATIONS

This application is based upon and claims the benefit of priority of the prior Japanese Patent Application No. 2009-265370, filed on Nov. 20, 2009, the entire contents of which are incorporated herein by reference.

### FIELD

The embodiments discussed herein are related to a telephone receiving system, a telephone device, and a telephone receiving method.

### BACKGROUND

Recently, mobile terminals such as mobile telephones have become increasingly sophisticated and multifunctional. For example, instead of merely speech terminals, terminals now are generally able to play digital contents such as music and videos.

Due to the advancement in sophistication and functionality of mobile telephones, users need to have greater knowledge to be able to use all the functions. Users with problems may not be aware that the problems may be due to function setting errors and the users may instead request repairs for manufacturing defects.

For example, many handsets now equip Bluetooth technology to enable wireless music play or hands-free talk. However, when the Bluetooth communication function is set to “on” in a terminal device, the battery of the mobile telephone will quickly run out even if no communication with another communication device (the headset in the above example) is taking place. As a result, battery operating times of mobile telephones will be shortened.

For this type of setting error, it is preferable that the user is advised to fix the problem by a telephone consultation service. First of all, the helpdesk staff will ask the user for current settings over the phone, and found the setting of the Bluetooth was the source of problem. Then the helpdesk staff can suggest setting the Bluetooth communication function “on” only when using the Bluetooth function, and set the Bluetooth function “off” at other times. However, it is very difficult to ask about all the function setting details and understand the terminal device setting conditions over the telephone. As a result, though the helpdesk staff cannot determine whether there are hardware defect or not, they have no way to reject the request for warranted repair or exchange with new one.

As prior art to address the above issues, technologies such as the OMA-DM (Device Management standard in Open Mobile Alliance), which defines functions for the remote control of mobile terminals through a terminal management server and for the check and repair of setting items, has been introduced for mobile telephones.

Also, a folding type of mobile telephone that includes a switch function configured to activate a switch when the mobile telephone is opened, and a control unit that sends a previously set specified number when the switch is activated is disclosed in Japanese Laid-open Patent Publication No. 2003-283636.

Also, Japanese Laid-open Patent Publication No. 2006-157962 discloses a mobile terminal that is connected via the internet to a center server and a maintenance center, and that has a function to send data representing a current location by a built-in GPS function to the center server, a function to send a function diagnosis result based on a self-diagnosis program included in the mobile terminal, and a function to contact the maintenance center when a breakdown is found as a result of the diagnosis and to request mobile terminal repairs.

### SUMMARY

According to an aspect of an embodiment, a telephone device includes a dialing operation receiving unit that receives a dialing operation, a creating unit that creates condition data that indicates a condition of a function of the telephone device when a telephone number that received by the dialing operation receiving unit is matched with a specified number; and a sending unit that sends the created condition data to a desired destination.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of an embodiment of a configuration of a telephone receiving system.

FIG. 2 is an example of a configuration of each device of the telephone receiving system illustrated in FIG. 1.

FIGS. 3A and 3B make up a flowchart illustrating an example of procedures of a telephone receiving.

FIG. 4 is an example of a screen when starting a diagnosis application.

FIG. 5 is an example of a screen for receiving a problem consultation topic.

FIGS. 6A and 6B illustrate examples of screens when switching to a self-diagnosis mode.

FIG. 7 is an example of another embodiment of a configuration of each device of the telephone receiving system illustrated in FIG. 1.

FIG. 8 is an example of an automated response message table.

FIG. 9 is a flowchart illustrating an example of procedures for activating a terminal management server when a diagnosis log is received.

FIGS. 10A and 10B illustrate examples of a diagnosis log.

FIG. 11 is a flowchart illustrating an example of a failure cause analysis procedure.

### DESCRIPTION OF EMBODIMENTS

Although the OMA-DM enabler will enable the operator at consultation service to obtain the setting values of the mobile phones remotely, it cannot determine whether or not setting details are what the user intended. Hence, an operator at a consultation service figures out the cause of a problem based on information elicited from the user and teaches the user how to address the problem.

Also, since communication control and data transmission control may be operated in parallel in recent mobile phones, it is possible that the changes carried out by the user while communicating may not be conveyed to the responder.

### First Embodiment

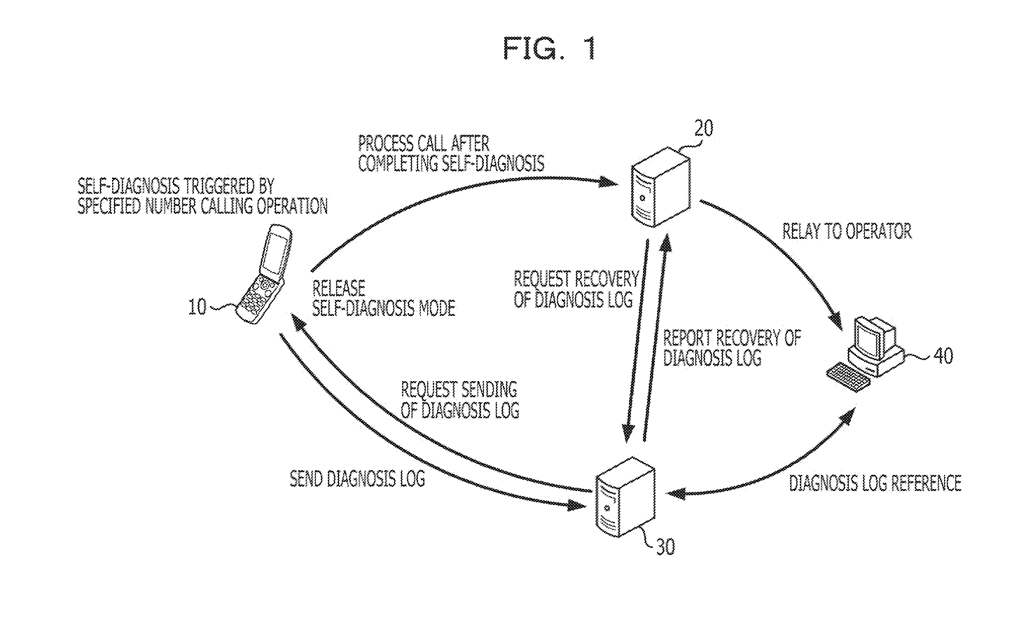

FIG. 1 is an example of a configuration of a telephone receiving system according to an embodiment discussed herein. A telephone receiving system according to the present embodiment includes, for example, a mobile telephone 10 held by an individual user, a communication server 20 that receives calls from the mobile telephone 10, a terminal management server 30 that manages conditions of the mobile telephone 10, and an operator terminal 40 that an operator uses to conduct telephone responses for calls using specified telephone numbers.

When it is determined that a problem has occurred in the mobile telephone 10, the user operates the mobile telephone 10 to call the specified telephone number. If a call to the specified telephone number is made, the mobile telephone 10 temporarily stops user operations and activates a self-diagnosis mode to create a diagnosis log. The diagnosis log includes information used in the diagnosis such as on/off states of functions, function settings, hardware physical information, and the like. Examples of this kind of information may include any type of information related to conditions of the mobile telephone 10 such as operating cursor sensitivity settings, LCD lights-out timer, Bluetooth on/off states, production date of the power source, number of times of charging, level of battery wear, built-in memory activity ratio, and the like. Furthermore, the settings at the time of shipping from the plant may be stored so that the diagnosis log is able to record setting items that have changed since being shipped. The mobile telephone 10 makes a call to the communication server 20 after creating the diagnosis log.

When the communication server 20 receives a call from the specified telephone number, the communication server 20 requests the terminal management server 30 to retrieve the diagnosis log from the mobile telephone 10. After receiving the request to retrieve the diagnosis log, the terminal management server 30 requests the mobile telephone 10 to send the diagnosis log. In the present embodiment, the DM (Device Management) protocol promoted by the OMA standardization may be used as the communication protocol between the mobile telephone 10 and the terminal management server 30.

After the mobile telephone 10 sends the diagnosis log to the terminal management server 30 in response to the sending request from the terminal management server 30, the mobile telephone 10 turns off the self-diagnosis mode.

When the terminal management server 30 receives the diagnosis log sent from the mobile telephone 10, the terminal management server 30 communicates that the diagnosis log has been recovered to the communication server 20. When the diagnosis log has been recovered, the communication server 20 relays the operations to the operator terminal 40. The operator of the operator terminal 40 refers to the mobile telephone 10 diagnosis log received by the terminal management server 30, finds the cause of the problem, and tells the user how to address the problem.

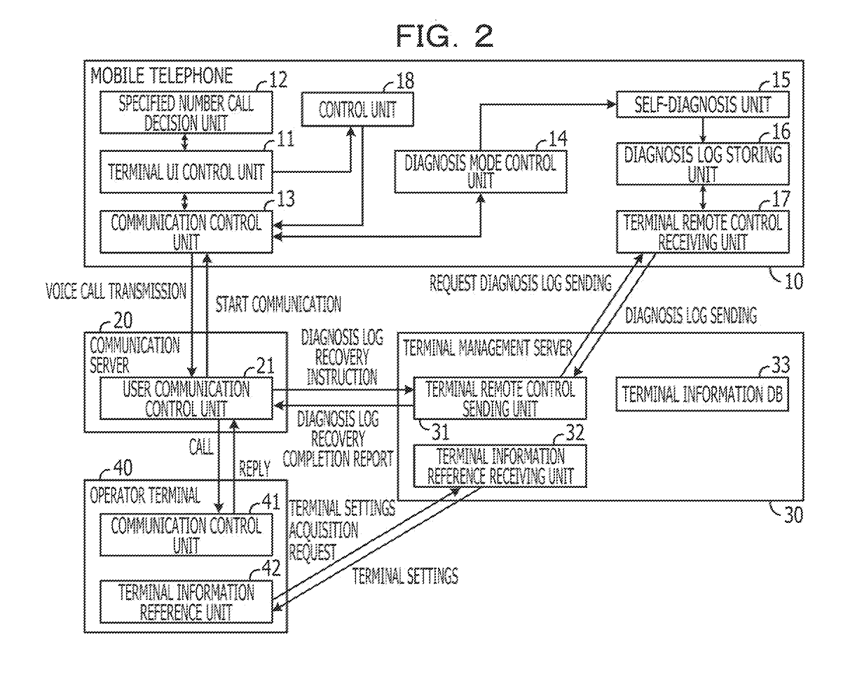

FIG. 2 is an example of a configuration of each device of the first embodiment illustrated in FIG. 1.

The mobile telephone 10 includes a terminal UI control unit 11, a specified number call decision unit 12, a communication control unit 13, a diagnosis mode control unit 14, a self-diagnosis unit 15, a diagnosis log storing unit 16, a terminal remote control receiving unit 17, and a control unit 18.

The terminal UI control unit 11 controls the user interface. For example, when conducting settings for calling, sending and receiving electronic mail, and other settings related to telephone functions, key operations using hardware and touch panel keys are received and the screen display is controlled according to the key operations. The contents of the received key operations are reported to the control unit 18.

The specified number call decision unit 12 decides whether or not a telephone number received by the terminal UI control unit 11 is a specified telephone number (for example, #115) when a call is made. The communication control unit 13 controls the communication based on the result of the decision by the specified number call decision unit 12. Specifically, when the telephone number received by the terminal UI control unit 11 is judged to be a specified number, the communication control unit switches the mode to the self-diagnosis mode. When the telephone number is not a specified number, a call is made to the inputted telephone number.

The diagnosis mode control unit 14 controls items related to the self-diagnosis mode. When the telephone number inputted through the terminal UI control unit 11 is a specified number and the self-diagnosis mode is started, the terminal UI control unit 11 causes the self-diagnosis unit 15 to execute the self-diagnosis and stores the resulting diagnosis log in the diagnosis log storing unit 16 while limiting terminal operations by the user.

The diagnosis mode control unit 14 has a control program and controls the communication control unit 13 and the self-diagnosis unit 15 according to the control program. In this way, the mobile telephone 10 functions as a telephone device according to the embodiment discussed herein.

The terminal remote control receiving unit 17 sends the saved diagnosis log to the diagnosis log storing unit 16 in response to a request from the terminal management server 30. Also, when the diagnosis log is sent, the self-diagnosis mode is released and the receiving of user operations is restarted since the operator is able to learn the conditions of the mobile telephone 10 at the time the problem occurred.

The control unit 18 controls the basic functions and other various functions of the mobile telephone 10 based on the contents of the key operations reported by the terminal UI control unit 11. For example, when the reported key operations are “operations related to calling,” call processing is conducted via the communication control unit 13. Furthermore, when the reported key operations are “operations related to sending and receiving an email,” email sending and receiving processing is conducted. When the reported key operations are “operations to conduct various settings related to telephone functions,” setting registration or change processes and the like are conducted.

These functions may not be consolidated in the control unit 18. Each of the functions may be installed as separate components and may operate according to instructions received from the control unit 18.

The communication server 20 includes a user communication control unit 21 and controls the timing of the start of communication of a voice call from the mobile telephone 10. Specifically, after the communication server 20 requests the terminal management server 30 to recover the diagnosis log, the operations are relayed to the operator when the report indicating that the diagnosis log has been recovered from the mobile telephone 10 has been received from the terminal management server 30, and communication between the user of the mobile telephone 10 and the operator starts.

The terminal management server 30 includes a terminal remote control sending unit 31, a terminal information reference receiving unit 32, and a terminal information database (DB) 33. The terminal remote control sending unit 31 requests the mobile telephone 10 to send the diagnosis log when a request to recover the diagnosis log is received from the communication server 20. The terminal information DB 33 saves the diagnosis log sent from the mobile telephone 10 in association with identification information that identifies the mobile telephone 10.

The terminal information reference receiving unit 32 receives a terminal setting acquisition request from the operator terminal 40 to allow the operator to refer to the diagnosis log saved in the terminal information DB 33, and then sends the requested diagnosis log to the operator terminal 40.

Also, a control program is stored in a storage unit (not illustrated) of the terminal management server 30. The terminal management server 30 is able to function as a management apparatus according to the present embodiment when the terminal management server 30 executes the control program.

The operator terminal 40 includes a communication control unit 41 and a terminal information reference unit 42. The communication control unit 41 controls communication with the communication server 20 and causes the operator terminal 40 to function as a telephone. The terminal information reference unit 42 refers to the diagnosis log(terminal settings) acquired by the terminal management server 30 and instructs the operator.

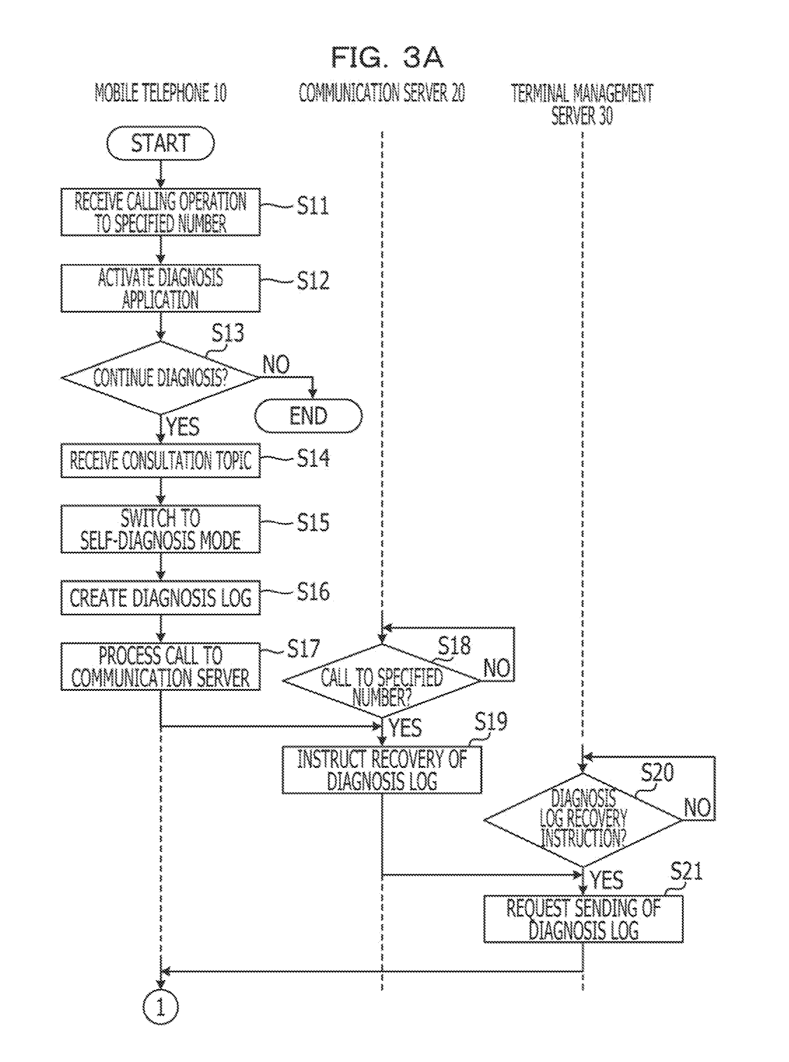

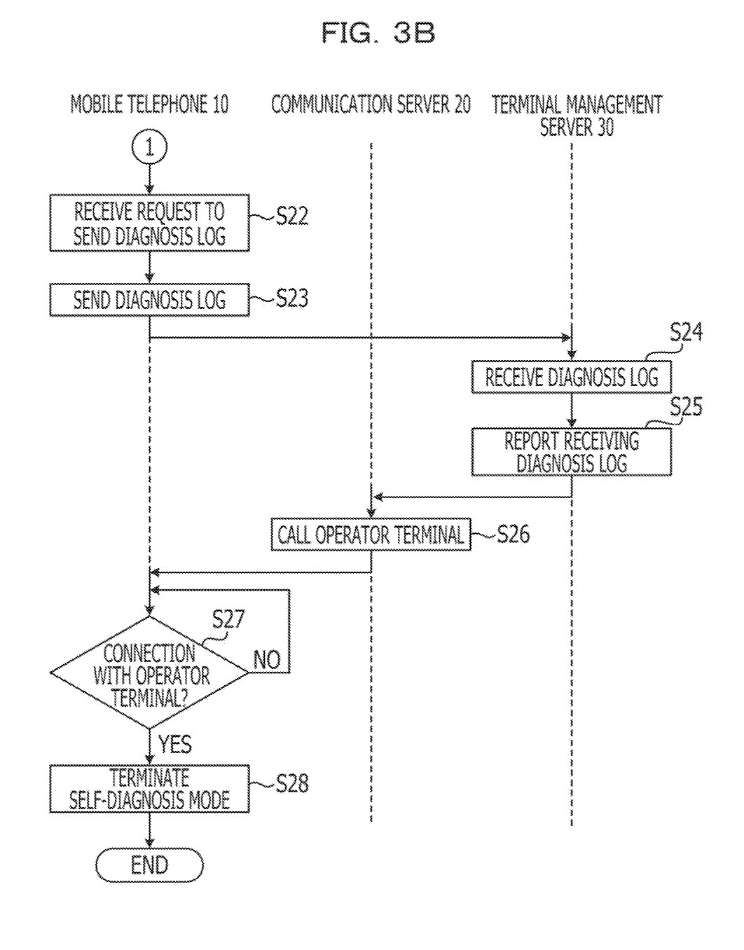

FIGS. 3A and 3B make up a flowchart illustrating an example of procedures of a telephone receiving. When the mobile telephone 10 receives a calling operation to a specified number (S11), the mobile telephone 10 activates a diagnosis application (S12). The mobile telephone 10 displays a screen to ask if the user wants to start the self-diagnosis, and then judges whether or not to continue the diagnosis operation (S13).

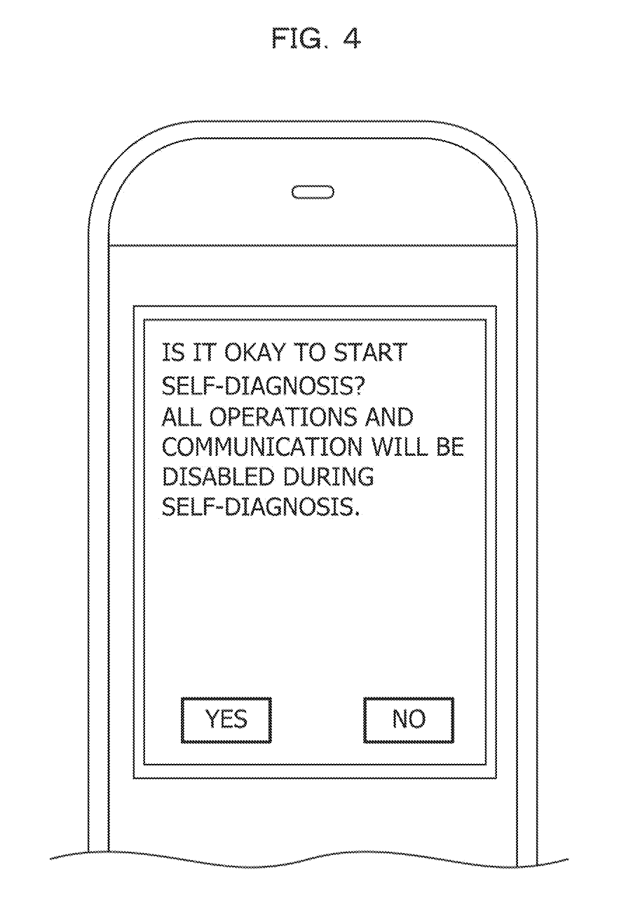

FIG. 4 is an example of a screen when starting a diagnosis application. In the example screen in FIG. 4, a message asking whether or not to start the self-diagnosis is displayed along with a message warning that communication and mobile telephone 10 operations are disabled during the self-diagnosis. The selection of whether or not to start the self-diagnosis is received through the key operation (hardware key or touch panel key operation) of the mobile telephone 10.

When the screen illustrated in FIG. 4 is displayed and the user decides to not start the self-diagnosis by operating the mobile telephone 10 keys to select “NO,” the mobile telephone 10 decides to not continue the diagnosis operation (S13: NO), and the processing of the flowchart is completed.

On the other hand, when the user decides to start the self-diagnosis by operating the mobile telephone 10 keys to select “YES,” the mobile telephone 10 decides to continue the diagnosis operation (S13: YES) and receives a problem consultation topic (S14).

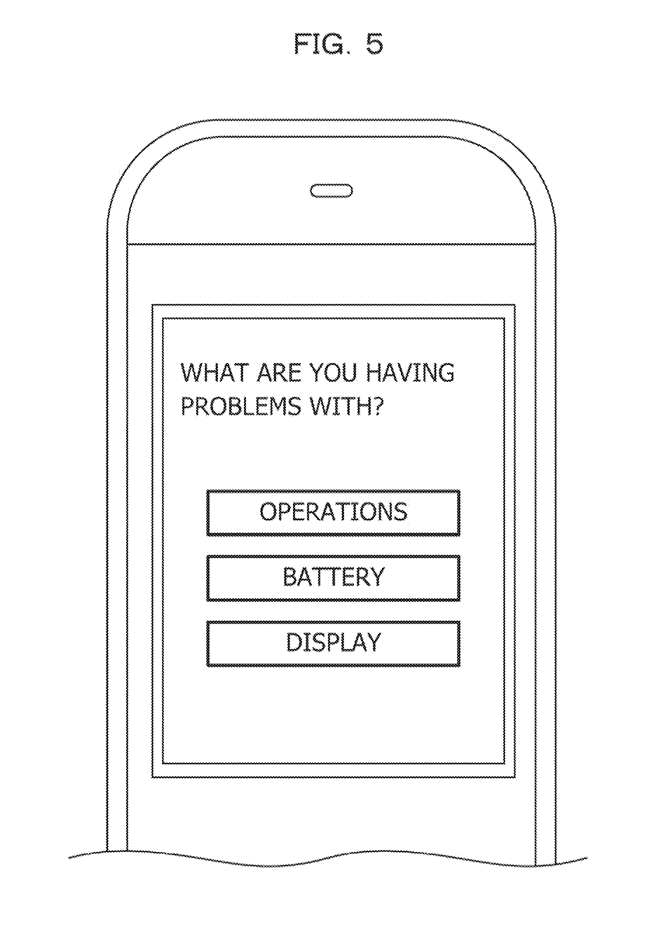

FIG. 5 is an example of a screen for receiving a problem consultation topic. The screen example illustrated in FIG. 5 is a screen for selecting the topic of the problem consultation as related to “operations,” “battery,” and “display.” Selection of the topic of the problem consultation is received through the operation of the mobile telephone 10 keys.

After receiving the topic of the problem consultation, the mobile telephone 10 switches to the self-diagnosis mode (S15). When switching to the self-diagnosis mode, the mobile telephone 10 displays a message indicating that the mobile telephone 10 setting details are being checked at this time, and prohibits mobile telephone 10 key input and output operations by the user. As a result, the mobile telephone 10 enters a state in which communication using the mobile telephone 10 is prohibited.

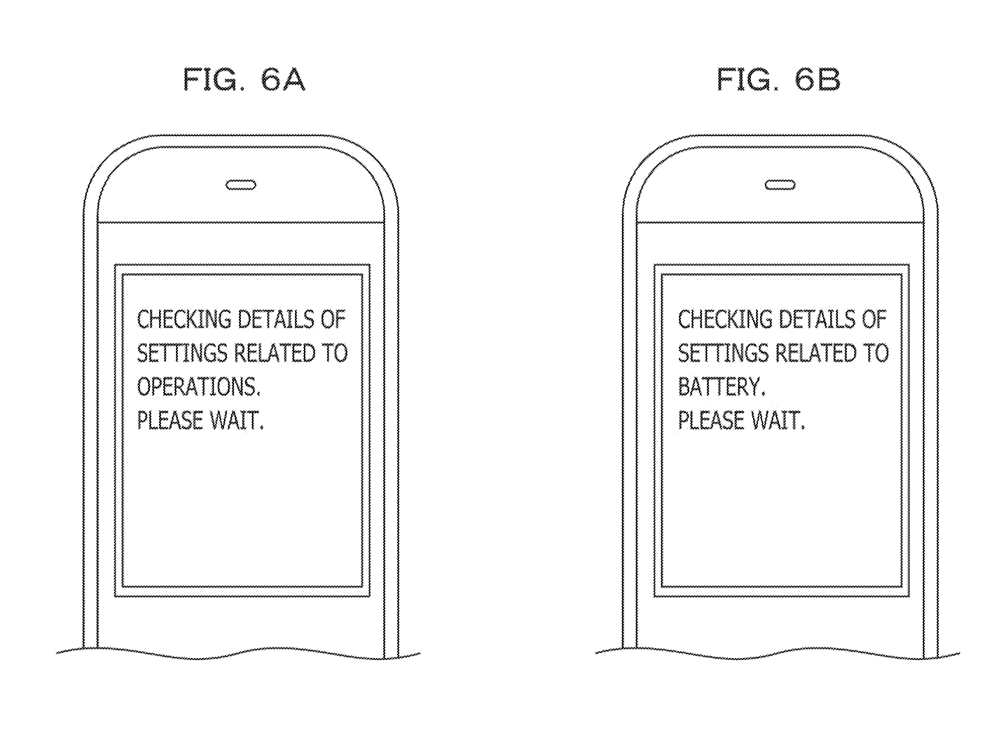

FIGS. 6A and 6B illustrate examples of screens when switching to the self-diagnosis mode. FIG. 6A illustrates a message that indicates there is a waiting period during the checking of the setting details related to the operations. FIG. 6B illustrates a similar message. Instead of checking the setting details in response to the problem consultation topic, the mobile telephone 10 may be configured to check all the setting details of the mobile telephone 10 regardless of the problem consultation topic.

The mobile telephone 10 records the checked setting details and the results of the check to create a diagnosis log(S16), and makes a call to the communication server 20 (S17).

The communication server 20 appropriately decides whether or not there is an incoming call to a specified number (S18). If no incoming call to the specified number is received (S18: NO), the communication server 20 waits until an incoming call is received. When the communication server 20 decides that there is an incoming call to a specified number (S18: YES), the communication server 20 instructs the terminal management server 30 to recover the diagnosis log (S19).

The terminal management server 30 appropriately decides whether or not a recovery instruction has been received from the communication server 20 (S20). When there is no recovery instruction (S20: NO), the terminal management server 30 waits until a recovery instruction is received. When the terminal management server 30 decides that a diagnosis log recovery instruction has been received (S20: YES), the terminal management server 30 sends a diagnosis log sending request to the mobile telephone 10 using OMA-DM (S21).

When the mobile telephone 10 receives the sending request from the terminal management server 30 (S22), the mobile telephone 10 sends the diagnosis log created at (S16) to the terminal management server 30 (S23). Contents complying with request contents written on page 47 to page 49 of the “DiagMon Functions Supplemental Specification Draft Version 1.0_{—}4 Nov. 2009” (document No.: OMA-TS-DiagMon_Functions-1_{—}0-20091104-D) being studied by the OMA Standard Organization may be included in the sending and receiving of the diagnosis logs. Also, diagnosis logs may be created based on other conventions or standards.

When the terminal management server 30 receives the diagnosis log sent by the mobile telephone 10 (S24), the terminal management server 30 notifies the communication server 20 that the diagnosis log has been received (S25). Having received the report indicating the receiving of the diagnosis log, the communication server 20 calls the operator terminal 40 to establish a connection between the mobile telephone 10 and the operator terminal 40 (S26).

After sending the diagnosis log at (S23), the mobile telephone 10 appropriately decides whether or not there is a connection with the operator terminal 40 (S27). If there is no connection with the operator terminal 40 (S27: NO), the mobile telephone 10 waits until a connection is made with the operator terminal 40.

If the mobile telephone 10 is connected to the operator terminal 40 (S27: YES), the mobile telephone 10 terminates the self-diagnosis mode (S28). After terminating the self-diagnosis mode, the mobile telephone 10 releases the operation prohibition of the mobile telephone 10 and allows communication between the mobile telephone 10 and the operator terminal 40. Since the operator terminal 40 has acquired the diagnosis log of the mobile telephone 10 at (S24), the operator is able to refer to the diagnosis log and instruct the user of the mobile telephone 10 how to address the problem. At this time, the terminal management server 30 may send a command to remotely address the problem by rewriting the mobile telephone 10 settings instead of addressing the problem through user operations.

As described above, in the embodiment discussed herein, when a connection is established between the mobile telephone 10 and the operator terminal 40, the operator terminal 40 acquires the diagnosis log of the mobile telephone 10 at the time the user realized a problem had occurred. Therefore, causes of problems may be found using the remotely acquired diagnosis log and communication with the user may be minimized while trying to address the problem, whether the failure is caused by a clear error, or whether there is an inquiry regarding a user's setting mistake.

Although, in the present embodiment, the mobile telephone 10 operations by the user are prohibited when switching to the self-diagnosis mode, operations that do not change the settings (for example, displaying information) may be allowed.

Although, in the present embodiment, the operator refers to the diagnosis log acquired by the terminal management server 30 for reference to find the cause of a problem, the terminal management server 30 may accumulate solution methods based on diagnosis results and inform the operator terminal 40 of solution methods for similar past diagnosis results as candidate solutions to address the problem.

Although, in the present embodiment, the mobile telephone 10 records the setting details as the diagnosis log, the mobile telephone 10 may list applications activated when switching to the diagnosis mode and record the diagnosis log as applications that may be the cause of a failure after reactivation. If the problem is related to the display, there are many cases in which added applications are the cause of the failure and thus a problem application may be identified.

The mobile telephone 10 of the present embodiment may be configured to save past failure records and send the records with the diagnosis log to the terminal management server 30. Also, after detecting a failure record, the mobile telephone 10 may be configured to not activate the self-diagnosis application when the failure conditions are clear and immediately send the failure record to the terminal management server 30.

### Second Embodiment

The first embodiment describes a configuration in which the communication server 20 establishes a connection between the mobile telephone 10 and the operator terminal 40 when a diagnosis log from the mobile telephone 10 is acquired by the terminal management server 30.

However, when the terminal management server 30 analyzes the cause of the failure and is able to send an automated response, the connection to the operator terminal 40 may not be initiated and a previously prepared message may be sent as a method to address the problem.

A second embodiment describes a configuration in which the terminal management server 30 analyzes the cause of a failure, decides whether or not an automated response is possible, and automatically responds based on the result of the decision, or allows an operator to choose a response.

Detailed explanations of the system configuration that are substantially similar to explanations in the first embodiment shall be omitted.

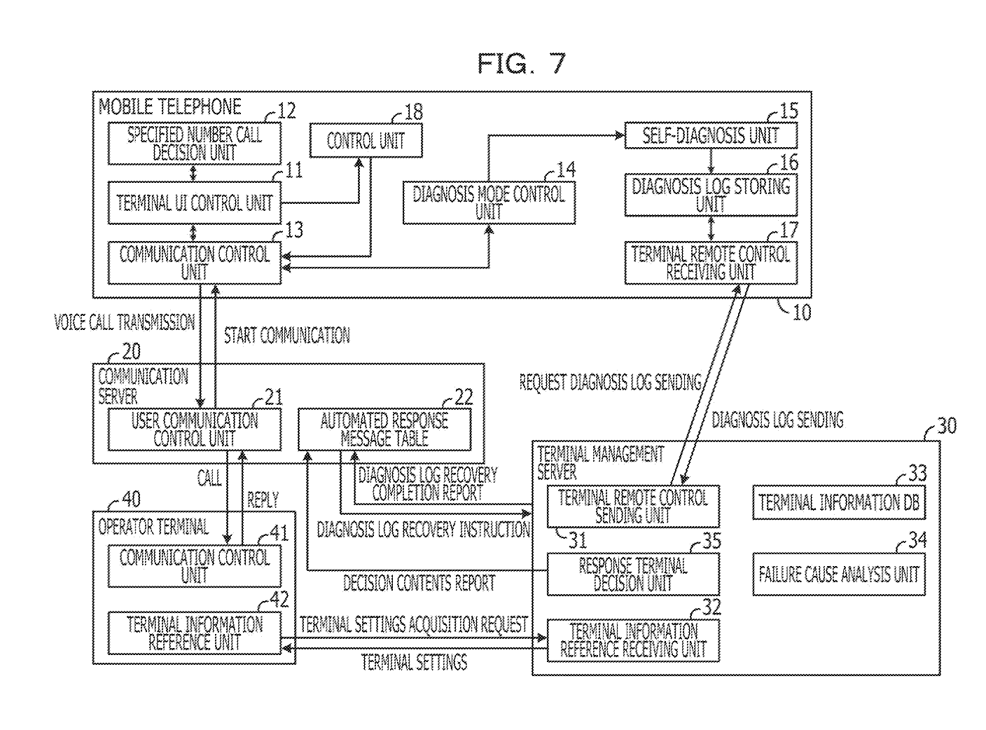

FIG. 7 is an example of a configuration of each device according to a second embodiment.

The communication server 20 is configured so that a voice response message to be sent to the mobile telephone 10 as an automated response is previously saved in an automated response message table 22, and then the applicable response message is sent to the mobile telephone 10 if there is an instruction from the terminal management server 30.

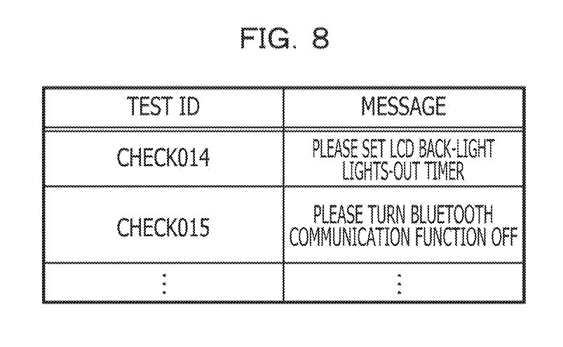

FIG. 8 is an example of the automated response message table 22. The automated response message table 22 stores response messages associated with test IDs. The test IDs are identifiers specified by the terminal management server 30 and are for identifying a voice message to be sent.

The terminal management server 30 includes a failure cause analysis unit 34 and a response terminal decision unit 35, along with the terminal remote control sending unit 31, the terminal information reference receiving unit 32, and the terminal information DB 33.

The failure cause analysis unit 34 analyzes whether or not the failure that occurred is one in which a solution method may be suggested from the automated responses based on the diagnosis log of the mobile telephone 10 received via the terminal remote control sending unit 31.

The response terminal decision unit 35 decides whether to provide an automated response from the terminal management server 30, or to connect to the operator terminal 40 to allow the operator to respond, according to the analysis result of the failure cause analysis unit 34. When the automated response is conducted, the response terminal decision unit 35 notifies the communication server 20 of the automated response and specifies the response message to be sent using the test ID. When an automated response is not conducted, the communication server 20 is instructed to call the operator terminal 40 in substantially the same way as described in the first embodiment.

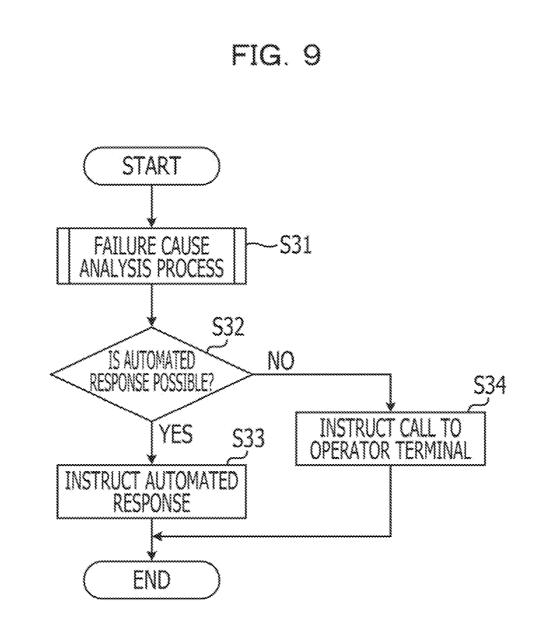

FIG. 9 is a flowchart illustrating an example of a procedure for activating the terminal management server 30 when the diagnosis log is received. Similar to the procedure illustrated in FIGS. 3A and 3B, when the terminal management server 30 receives the diagnosis log sent from the mobile telephone 10, the terminal management server 30 conducts a failure cause analysis process as described below (S31).

The terminal management server 30 judges whether or not an automated message is possible based on the result of the failure cause analysis (S32). When the automated response is judged to be possible (S32: YES), the response message to be sent is specified and the communication server 20 is notified that an automated response is to be sent (S33). On the other hand, when the automated response is judged not to be possible (S32: NO), the communication server 20 is instructed to call the operator terminal 40 (S34).

After receiving the instruction from the terminal management server 30 that an automated response is to be sent, the communication server 20 instructs the mobile telephone 10 to release the self-diagnosis mode and causes the mobile telephone 10 to switch to allowing mobile telephone 10 operations and voice communication. When the self-diagnosis mode is released, the mobile telephone 10 informs the communication server 20 that the self-diagnosis mode has been released. After the self-diagnosis mode has been released by the mobile telephone 10, the communication server 20 reads the response message specified by the terminal management server 30 when the instruction to conduct the automated response is received, and sends the response message to the mobile telephone 10.

Even when an automated response message is sent to the mobile telephone 10, a method to allow mobile telephone 10 operations to establish a connection to the operator terminal 40 to allow the user to talk directly with the operator to ask questions unrelated to the diagnosis result and the like may further be included.

On the other hand, as in the first embodiment, when the communication server 20 is instructed by the terminal management server 30 to call the operator terminal 40, the communication server 20 may establish a connection between the mobile telephone 10 and the operator terminal 40 to allow the operator to provide the solution method.

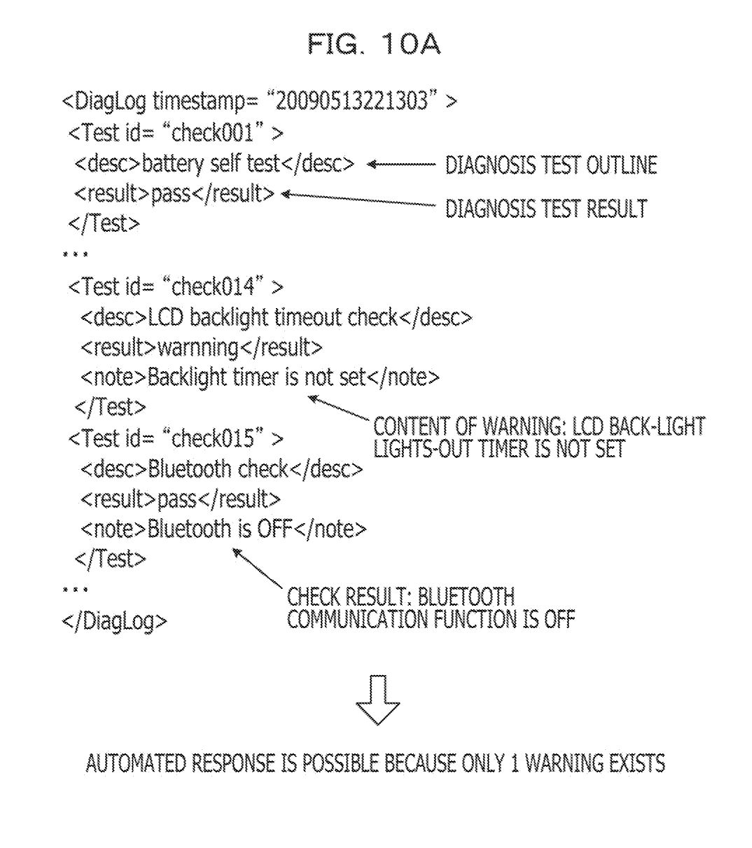

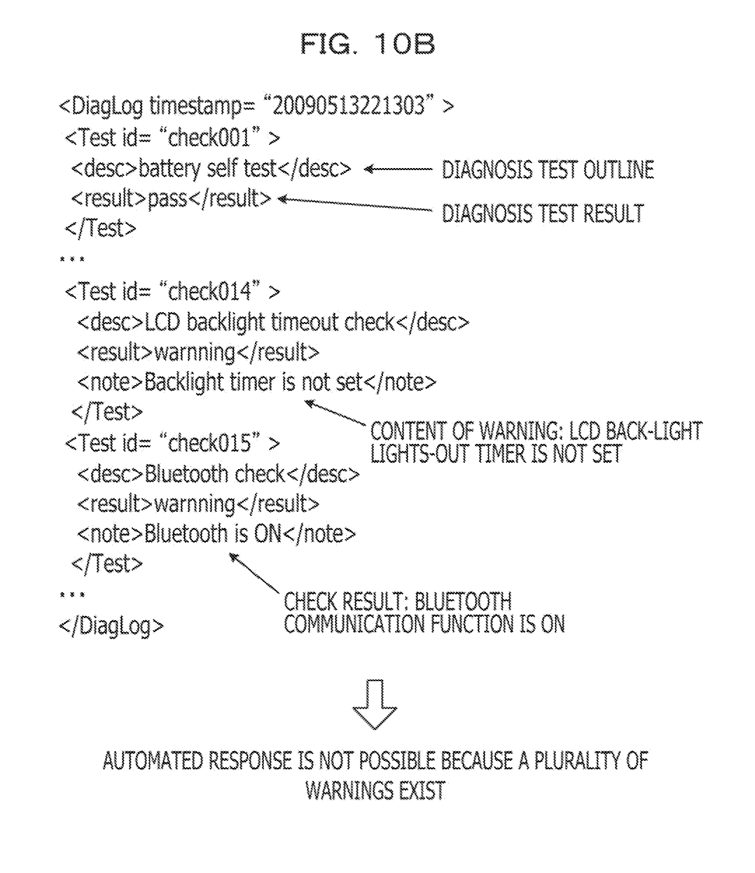

FIGS. 10A and 10B illustrate examples of a diagnosis log. FIG. 10A is an example of a diagnosis log for which an automated response is possible, and FIG. 10B is an example of a diagnosis log for which an automated response is not possible.

FIGS. 10A and 10B illustrate results of the self-diagnosis by the mobile telephone 10 on settings related to the mobile telephone 10 LCD back-light lights-out timer and to Bluetooth communication functions, for diagnosing problems related to the battery.

In the diagnosis log in FIG. 10A, the indication that the LCD back-light lights-out timer is not set is identified as a possible cause of the problem related to the battery (fast depletion of the battery), and this is reported as the subject of a warning. Also, in the diagnosis log in FIG. 10A, the indication that setting the Bluetooth communication function to “off” does not affect any battery-related problems is identified, and is diagnosed as not applicable to the warning (“pass”).

In this way, the terminal management server 30 that acquires the diagnosis log illustrated in FIG. 10A decides that an automated response is possible since, as a result of the diagnosis of the problem related to the battery of the mobile telephone 10, the subject of the warning to be sent may be limited to one.

In the diagnosis log in FIG. 10B, the indication that the LCD back-light lights-out timer is not set is also identified as a possible cause of the problem related to the battery, and this is reported as the subject of the warning. Furthermore, in the diagnosis log in FIG. 10B, the indication that the Bluetooth communication function is set to “on” is identified as a possible cause of the problem related to the battery, and this is also reported as the subject of the warning.

In this way, as a result of the diagnosis of the problem related to the battery, a plurality of warning subjects exist and so the terminal management server 30 that acquires the diagnosis log connects the mobile telephone 10 being used by the user to operator terminal 40 being used by the operator to address the problem by allowing the user and the operator to communicate and narrow down the cause.

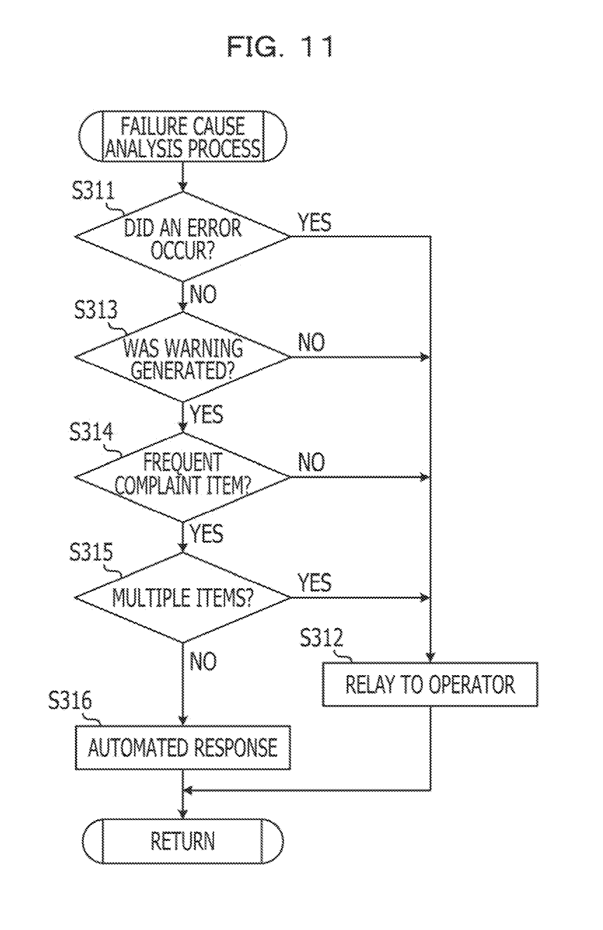

FIG. 11 is a flowchart illustrating a failure cause analysis procedure. The terminal management server 30 decides whether or not an error has occurred in the mobile telephone 10 based on the diagnosis log sent from the mobile telephone 10 (S311). When the terminal management server 30 decides that an error has occurred (S311: YES), the terminal management server 30 does not carry out the automated response and decides to relay the operations to the operator (S312) since there is a possibility of a breakdown in the mobile telephone 10 and a repair might be needed.

When the terminal management server 30 decides that an error has not occurred in the mobile telephone 10 (S311: NO), the terminal management server 30 decides whether or not a warning was generated (S313). When the terminal management server 30 decides that a warning was not generated (S313: NO), the terminal management server 30 does not carry out an automated response and decides to relay the operations to the operator (S312) since there is no problem with the mobile telephone 10 settings and listening to the complaint from the user is desired.

When the terminal management server 30 decides that the warning was generated (S313: YES), the terminal management server 30 decides whether or not the warning is a frequent complaint item (S314). When the terminal management server 30 decides that the warning is not a frequent complaint item (S314: NO), the terminal management server 30 does not carry out an automated response and decides to relay the operations to the operator (S312) since listening to the user to discuss the solution method is desired.

When the terminal management server 30 decides that the warning is a frequent complaint item (S314: YES), the terminal management server 30 decides whether or not there are multiple items (S315). When the terminal management server 30 decides that there are multiple items (S315: YES), the terminal management server 30 does not carry out an automated response and decides to relay the operations to the operator (S312) since listening to the user to identify the problem is desired.

When the terminal management server 30 decides that there are not multiple items (S315: NO), the terminal management server 30 decides to conduct an automated response (S316).

It is stated above that when the warning that occurs in (S314) is a frequent complaint item, the terminal management server 30 decides whether or not there are multiple items according to the second embodiment. However, the terminal management server 30 may be configured to prepare response messages addressing the frequent complaint items ahead of time and send an automated response when applicable regardless of whether there are multiple items or not.

For example, there are many cases in which a charging circuit safety system is activated due to heating of the mobile telephone 10, and the charging is interrupted before charging is finished. The terminal management server 30 may send a message to the user of the mobile telephone 10 saying “The battery has become sensitive to heating of the device. Please exchange the battery” when the terminal management server 30 receives a log that indicates that the surface temperature of the mobile telephone 10 exceeds 30 degrees Celsius and the remaining battery power is 10% or less.

As indicated above in the present embodiment, when the terminal management server 30 receives from the mobile telephone 10 a problem consultation that may handled with an automated message, the terminal management server 30 may to address the problem by sending a previously stored response message to the communication server 20. In this way, the workload of the operator may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A telephone device, comprising:
a dialing operation receiving unit that receives a dialing operation;
a creating unit that creates condition data that indicates a condition of a function of the telephone device when a telephone number that received by the dialing operation receiving unit is matched with a specified number; and
a sending unit that sends the created condition data to a desired destination.

2. The telephone device according to claim 1, further comprising:
a function setting accepting unit that accepts changes on setting of the function; and
a control unit that disables the function of setting accepting unit when the telephone number that received by the dialing operation receiving unit is matched with the specified telephone number, and enables the function of setting accepting unit based on a response to the dialing operation to the specified telephone number.

3. The telephone device according to claim 1, further comprising:
a diagnosis unit that diagnoses a problem based on the created condition data, and outputs diagnosis information,
wherein the sending unit sends the diagnosis information to the desired destination.

4. A telephone receiving system comprising:
an user communication control unit that receives a call from a telephone device; and
an terminal remote control sending unit that acquires condition data that indicates a condition of a function of the telephone device and receives the condition data from the telephone device,
wherein the user communication control unit executes one of an automated response to the received call and a relay of the received call to an operator terminal based on the received condition data.

5. The telephone receiving system according to claim 4, further comprising:
an analysis unit that analyzes the received condition data and identifies a problem,
wherein the user communication control unit executes the automated response and the relay based on the identified problem.

6. A management apparatus comprising:
a request sending unit that sends, to a telephone device, an acquisition request for condition data that indicates a condition of a function on the telephone device;
a receiving unit that receives the condition data from the telephone device; and
an analysis unit that analyzes the received condition data and identifies a problem.

7. The management apparatus according to claim 6, further comprising:
a deciding unit that decides whether to conduct one of an automated response to a incoming call of the telephone device and a relay of the call of the telephone device to an operator terminal based on the received condition data; and
a reporting unit that reports the decision to the call to a desired destination.

8. The management apparatus according to claim 7, further comprising:
a storing unit that stores the condition of the function and other reporting information which are associated with a user,
wherein the deciding unit makes the decision to conduct the automated response to the call of the telephone device based on the reporting information stored in the storing unit in association with the identified condition of the function.

9. The management apparatus according to claim 7,
wherein the deciding unit decides to conduct the automated response only when one warning was reported and decides to relay the call of the telephone device to the operator terminal in other cases.

10. The management apparatus according to claim 7, further comprising:
a history recording unit that stores records of an analysis result made by the analysis unit,
wherein the deciding unit decides to conduct the automated response when the identified condition of the function was matched with a record in storing unit which was frequently reported.

11. The management apparatus according to claim 6, further comprising:
a setting changing unit that changes a setting related to a function of the telephone device.

12. A telephone receiving method comprising:
using a computer processor,
receiving a call from a telephone device;
sending, to the telephone device, an acquisition request to acquire condition data that indicates a condition of a function of the telephone device;
receiving the condition data from the telephone device; and
executing one of an automated response to the received call or a relay of the received call to an operator terminal based on the received condition data.
